(19) United States
(12) Patent Application Publication
(10) Pub. No.: US 2008/0014852 A1
(43) Pub. Date: Jan. 17, 2008

(54) Air conditioner control for vehicular no-idle system using batteries

(76) Inventors: Richard A. Mielke, Franksville, WI (US); Stephen B. Memory, Kenosha, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/484,399

(22) Filed: Jul. 11, 2006

(51) Int. Cl. B60H 1/00

(52) U.S. Cl. 454/75

(57) ABSTRACT

An HVAC control system for a passenger compartment of an over the road vehicle comprises a controllable air conditioner for directing cooled air flow through the passenger compartment and a controllable heater for directing heated air flow through the passenger compartment. A battery selectively powers the air conditioner and the heater. A sensor senses battery energy. A control panel includes user input devices for manually selecting operating parameters of the HVAC system and a battery remaining time display. A controller is operatively connected to the air conditioner, the sensor and the user control panel, the controller determining estimated battery remaining time based on battery energy and the manually selected operating parameters, and displaying the estimated battery remaining time on the battery remaining time display.

### CROSS REFERENCE TO RELATED APPLICATIONS

There are no related applications.

### FIELD OF THE INVENTION

The invention relates to vehicle HVAC systems and, more particularly, to HVAC systems for the passenger compartments of large vehicles.

### BACKGROUND OF THE INVENTION

Currently, air conditioning systems for vehicles, and particularly for the passenger compartments of large vehicles, such as trucks, is provided via an engine driven air conditioning system. However, concern over pollution, both air and noise, is creating the potential that trucks will no longer be allowed in some instances to idle their engines in order to operate the air conditioning for the passenger compartment. In addition to concerns over pollution, it has been estimated that the costs for overnight idling include $2,400 per year in fuel consumption and $250 per year in added maintenance. With respect to air pollution, it has been estimated that a single truck idling for one year produces 250 lbs. of CO, 615 lbs. of NOₓ, and 17 tons of CO₂.

More recently, modular HVAC systems for passenger compartments have been developed which are generally modular or self-contained. Some or all of the modular components are located in the passenger compartment. Electrical power for the HVAC system can be provided by the vehicle's electrical system. Energy saving with a passenger compartment HVAC module can be important, particularly when a vehicle engine is off and separate power sources are not available, requiring the passenger compartment HVAC module to run off battery power. The batteries may not have enough energy to provide maximum heating or cooling for the planned no-idle time. Known HVAC systems automatically control HVAC operation when running off batteries or may limit operation. This removes controllability from the user.

### SUMMARY OF THE INVENTION

The present invention is directed to a control for HVAC systems for a passenger compartment of an over the road vehicle.

There is disclosed in accordance with one aspect of the invention a method of operating an air conditioner (AC) system for a passenger compartment of an over the road vehicle. The AC system is controllable for directing cooled air flow through the passenger compartment. The AC system is selectively powered from a battery if the vehicle engine is off. The method comprises calculating battery capacity; a user manually selecting operating parameters of the AC system; determining estimated battery remaining time based on battery capacity and the manually selected operating parameters; and displaying the estimated battery remaining time for the user.

It is a feature of the invention that calculating battery capacity comprises sensing battery energy and calculating available capacity based on the battery energy.

It is another feature of the invention that determining estimated battery remaining time comprises determining power requirements based on a level of the manually selected operating parameters.

It is a further feature of the invention that the air conditioner system comprises a variable speed compressor and wherein determining estimated battery remaining time comprises determining power requirements based on a level of manually selected compressor speed.

It is still another feature of the invention that the air conditioner comprises a variable speed blower and wherein determining estimated battery remaining time comprises determining power requirements based on a level of manually selected blower speed.

It is still a further feature of the invention that determining estimated battery remaining time comprises determining ambient conditions and power requirements based on a level of the manually selected operating parameters under the determined ambient conditions.

There is disclosed in accordance with another aspect of the invention a method of operating an HVAC system for a passenger compartment of an over the road vehicle. The HVAC system includes a controllable air conditioner and a controllable heater, for respectively directing cooled or heated air flow through the passenger compartment. The HVAC system is selectively powered from a battery if the vehicle engine is off. The method comprises calculating battery capacity; a user manually selecting a heating mode or a cooling mode and operating parameters of the selected mode; determining estimated battery remaining time based on battery capacity and the manually selected operating parameters; and displaying the estimated battery remaining time for the user.

There is disclosed in accordance with a further aspect of the invention, an AC control system for a passenger compartment of an over the road vehicle comprising a controllable air conditioner for directing cooled air flow through the passenger compartment. A battery selectively powers the air conditioner. A control panel includes user input devices for manually selecting operating parameters of the AC system and a battery remaining time display. A controller is operatively connected to the air conditioner, the battery and the user control panel. The controller determines estimated battery remaining time based on the manually selected operating parameters and displays the estimated battery remaining time on the battery remaining time display.

It is a feature of the invention to provide a battery energy sensor and wherein the controller calculates battery capacity using sensed battery energy.

It is another feature of the invention that the controller determines estimated battery remaining time based on battery capacity and the manually selected operating parameters.

It is a further feature of the invention that the controller determines power requirements based on a level of the manually selected operating parameters.

There is disclosed in accordance with a further aspect of the invention, an HVAC control system for a passenger compartment of an over the road vehicle comprising a controllable air conditioner for directing cooled air flow through the passenger compartment and a controllable heater for directing heated air flow through the passenger compartment. A battery selectively powers the air conditioner and the heater. A sensor senses battery energy. A control panel includes user input devices for manually selecting operating parameters of the HVAC system and a battery remaining time display. A controller is operatively connected to the air conditioner, the sensor and the user control panel, the controller determining estimated battery remaining time based on battery energy and the manually selected operating parameters, and displaying the estimated battery remaining time on the battery remaining time display.

Further features and advantages of the invention will be readily apparent from the specification and from the drawings.

### BRIEF DESCRIPTION OF THE DRAWINGS

FIG. 1 is a combined electrical schematic and block diagram for an HVAC system for a passenger compartment of an over the road vehicle in accordance with the invention; and

FIG. 2 is a flow diagram illustrating control logic implemented by the HVAC system of FIG. 1 for determining estimated battery remaining time.

### DETAILED DESCRIPTION OF THE INVENTION

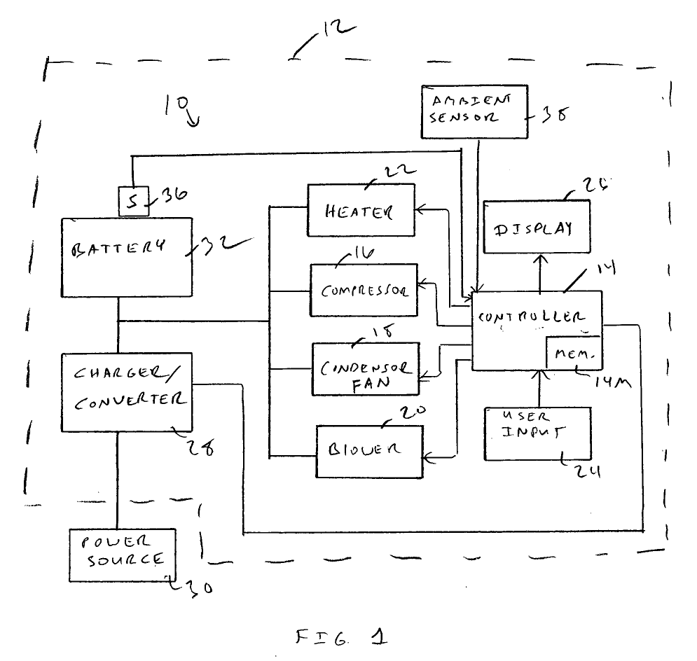

With reference to FIG. 1, the invention relates to a heating, ventilation and air conditioning (HVAC) module or system 10 that maintains comfortable temperatures in a passenger compartment of a vehicle, represented by the outline 12, without operating the main engine by utilizing an electronic control scheme in a controller 14 that efficiently matches the heating and/or cooling output to the heating and/or cooling requirements. The passenger compartment 12 may comprise a sleeper compartment and/or the cab or driver compartment.

The HVAC system 10 consists of selected HVAC components and sensors that can be controlled to deliver cooling capacity as required while minimizing the power consumed. For air conditioning, the HVAC system 10 may include a compressor 16, a condenser fan 18, and an evaporator blower 20. The HVAC system 10 may conventionally includes additional components (not shown) such as a condenser, a pressure reduction device, such as an expansion valve, thermostatic expansion valve, orifice tube, and preferably an electronically controlled expansion valve, and an evaporator, all connected in series in a refrigerant flow path with the compressor 20, as is known. The air conditioning system components themselves may be conventional in nature. An exemplary such air conditioning system is shown and described in an application entitled “Energy Efficient Capacity Control System For An Air Conditioning System”, Ser. No. 11/130,576, filed May 17, 2005, the specification of which is hereby incorporated by reference herein. The evaporator blower 20 directs cooled air flow through the passenger compartment 12, as is conventional.

The HVAC system 10 may also includes a heater 22. The heater 22 may be a conventional fuel fired heater or a resistance heater. The heater 22 may be operated at select levels to direct heated air flow through the passenger compartment 12, as is conventional.

The HVAC system 10 may include an operator interface provided by a user input device 24 and a display 26 connected to the controller 14. The controller 14 is also electrically connected to and controls the compressor 16, the condenser fan 18, the evaporator blower 20, and the heater 22.

The HVAC system 10 may include a power system module in the form of a charger/converter 28 connected to a power source 30, such as a conventional vehicle alternator, and/or a vehicle battery and/or to a 110 volt AC power source for use of shore power. The HVAC system 10 in a no-idle, engine off condition is powered by a battery 32 providing DC power, such as 24 volt DC power to power the compressor 16, the condenser fan 18, the evaporator blower 20, and the heater 22. The battery 34 includes a sensor 36 for sensing battery energy. The battery sensor 36 is connected to the controller 14. An ambient sensor block 38 is also connected to the controller 14 for sensing ambient parameters such as passenger compartment temperature, external temperature, or the like.

The HVAC system 10 may be mounted in one or more housings mounted in the passenger compartment 12. The present invention is not directed to the particular form of the HVAC system per se, but rather to the control used in the HVAC system 10, as described below.

The controller 14 may comprise a logic controller of any known form, including a memory 14M, for controlling the various controlled devices. The user input device 24 may include any type of input element such as push buttons, control knobs, touch screen, or the like. The user input device 24 can control both heating and cooling modes and heat and cooling output levels. The display 26 may display various operating parameters including, in accordance with the invention, battery remaining time. The operating parameters may include shore power operation, when battery power is used and a low battery condition.

In an illustrative embodiment of the invention, the heating mode and the cooling mode may provide a plurality of discreet output levels, or may be continuously variable. The presented invention is not directed to any particular heating or cooling mode.

In accordance with the invention, the controller 14 determines estimated battery remaining time based on the manually selected operating parameters from the user input device 24, battery energy and ambient conditions and displays the estimated battery remaining time on the display 26. The controller 14 is connected to the battery sensor 36 to calculate battery capacity. The controller 14 then estimates battery life or battery remaining time based on the heating or cooling level selected and the calculated battery capacity. The memory 14M stores a control program for determining the estimated battery remaining time. The memory 14M also stores parameters relating to power usage characteristics of the HVAC components such as the compressor 16, the condenser fan 18, the evaporator blower 20, and the heater 22. The estimated battery remaining time can be calculated using various different known algorithms. The calculation can be as simple as determining capacity, using a watt-hour rate for the battery, less capacity already consumed, divided by the load power to be consumed depending on the particular user setting. This provides the user the flexibility to select the level of heating or cooling. The controller 14 then determines estimated battery remaining time based on the capacity and the manually selected settings. Feedback is provided to the user in the form of displaying the estimated battery remaining time. The user, knowing the approximate no-idle time, can then determine if a different setting should be selected. Other embedded ambient inputs that could be used to calculate estimated battery remaining time are outside temperature, inside temperature, time of day, month of year and global position. Further inputs that could be included are position of a curtain between a sleeper cab and day cab, desired maximum inside temperature, or other heat sources likely to be used in the passenger compartment, such as microwave, lights and television.

The battery capacity can be calculated using various known techniques. Knowing the amount of energy remaining compared to what is available from a new battery provides the user with an indication of how long the battery will continue to operate before it needs to be recharged. Some of the known methods of determining the state of charge comprise a direct measurement, specific gravity measurements, voltage based estimation or current based estimation. The present invention is not directed to the particular algorithm for determining estimated battery remaining time, but rather to a system and method for providing an indication to a user based on different selected operating parameters of the HVAC system 10.

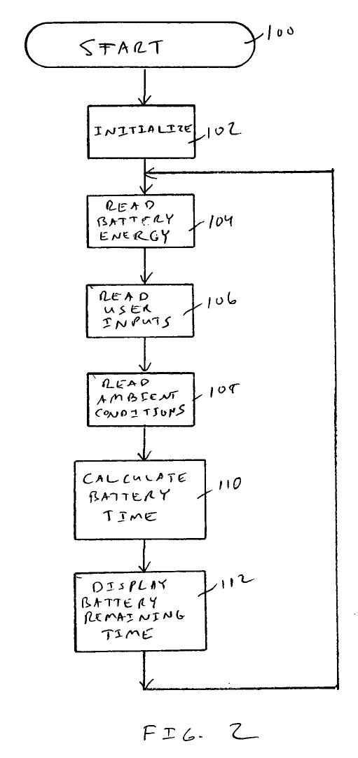

Referring to FIG. 2, a flow diagram illustrates operation of a control program in the controller 14 for determining and displaying estimated battery remaining time. The program begins at a start node 100 and advances to an initialize block 102. The initialize block 102 performs basic initialization routines and loads power consumption values for the equipment being used and based on operating levels of the equipment being used. A block 104 reads the battery energy level using information from the sensor 36, see FIG. 1. A block 106 reads the user inputs from the device 24 to determine, for example, the operating mode, as well as the information such as compressor speed, blower speed, heat output, or the like. The ambient conditions from the ambient sensor 38 is read at a block 108. The estimated battery remaining time is calculated at a block 110. The battery remaining time is calculated based on the battery level read at the block 104, as discussed above, along with the power requirements for the mode determined at the block 106, and ambient conditions. The estimated battery remaining time is then displayed on the display 26, see FIG. 1, at a block 112. The program then returns back to the block 104 to repeat the routine. As such, the routine is repeated to provide a real time estimated battery remaining time based on current battery conditions as well as the current mode selection.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

Thus, there is disclosed a system and method providing an indication of estimated battery remaining time in HVAC systems for a passenger compartment of an over the road vehicle.

We claim:

1. A method of operating an air conditioning (AC) system for a passenger compartment of an over the road vehicle, the AC system being controllable for directing cooled air flow through the passenger compartment, the AC system being selectively powered from a battery if a vehicle engine is off, the method comprising:
calculating battery capacity;
a user manually selecting operating parameters of the AC system;
determining estimated battery remaining time based on battery capacity and the manually selected operating parameters; and
displaying the estimated battery remaining time for the user.

2. The method of claim 1 wherein calculating battery capacity comprises sensing battery energy and calculating available capacity based on the battery energy.

3. The method of claim 1 wherein determining estimated battery remaining time comprises determining power requirements based on a level of the manually selected operating parameters.

4. The method of claim 1 wherein the AC system comprises a variable speed compressor and wherein determining estimated battery remaining time comprises determining power requirements based on a level of manually selected compressor speed.

5. The method of claim 1 wherein the AC system comprises a variable speed blower and wherein determining estimated battery remaining time comprises determining power requirements based on a level of manually selected blower speed.

6. The method of claim 1 wherein determining estimated battery remaining time comprises determining ambient conditions and power requirements based on a level of the manually selected operating parameters under the determined ambient conditions.

7. A method of operating a heating, ventilation, and air conditioning (HVAC) system for a passenger compartment of an over the road vehicle, the HVAC system including a controllable air conditioner and a controllable heater, for respectively directing cooled or heated air flow through the passenger compartment, the HVAC system being selectively powered from a battery if a vehicle engine is off, the method comprising:
calculating battery capacity;
a user manually selecting a heating mode or a cooling mode and operating parameters of the selected mode;
determining estimated battery remaining time based on battery capacity and the manually selected operating parameters; and
displaying the estimated battery remaining time for the user.

8. The method of claim 7 wherein calculating battery capacity comprises sensing battery energy and calculating available capacity based on the battery energy.

9. The method of claim 7 wherein determining estimated battery remaining time comprises determining power requirements based on a level of the manually selected operating parameters.

10. The method of claim 7 wherein the air conditioner system comprises a variable speed compressor and wherein determining estimated battery remaining time comprises determining power requirements based on a level of manually selected compressor speed.

11. The method of claim 7 wherein the air conditioner system comprises a variable speed blower and wherein determining estimated battery remaining time comprises determining power requirements based on a level of manually selected blower speed.

12. The method of claim 7 wherein determining estimated battery remaining time comprises determining ambient conditions and power requirements based on a level of the manually selected operating parameters under the determined ambient conditions.

13. An air conditioner (AC) control system for a passenger compartment of an over the road vehicle, comprising:
a controllable air conditioner for directing cooled air flow through the passenger compartment;
a battery for powering the air conditioner;
a control panel including user input devices for manually selecting operating parameters of the AC system, and a battery remaining time display; and
a controller operatively connected to the air conditioner, the battery and the user control panel, the controller determining estimated battery remaining time based on the manually selected operating parameters, and displaying the estimated battery remaining time on the battery remaining time display.

14. The AC control system of claim 13 further comprising a battery energy sensor and wherein the controller calculates battery capacity using sensed battery energy.

15. The AC control system of claim 14 wherein the controller determines estimated battery remaining time based on battery capacity and the manually selected operating parameters.

16. The AC control system of claim 13 wherein the controller determines power requirements based on a level of the manually selected operating parameters.

17. An HVAC control system for a passenger compartment of an over the road vehicle, comprising:
a controllable air conditioner for directing cooled air flow through the passenger compartment;
a controllable heater for directing heated air flow through the passenger compartment;
a battery for powering the air conditioner and the heater;
a sensor for sensing battery energy;
a control panel including user input devices for manually selecting operating parameters of the HVAC system, and a battery remaining time display; and
a controller operatively connected to the air conditioner, the sensor and the user control panel, the controller determining estimated battery remaining time based on battery energy and the manually selected operating parameters, and displaying the estimated battery remaining time on the battery remaining time display.

18. The AC control system of claim 17 further comprising a battery energy sensor and wherein the controller calculates battery capacity using sensed battery energy.

19. The AC control system of claim 18 wherein the controller determines estimated battery remaining time based on battery capacity and the manually selected operating parameters.

20. The AC control system of claim 17 wherein the controller determines power requirements based on a level of the manually selected operating parameters.
